(19) United States
(12) Patent Application Publication
(10) Pub. No.: US 2025/0262583 A1
(43) Pub. Date: Aug. 21, 2025

(54) DEVICE FOR CAPTURING LIQUID PARTICLES IN A GASEOUS FLOW

(71) Applicants: TALLANO TECHNOLOGIES, Paris (FR); AKWEL, Champfromier (FR)

(72) Inventors: Lotfi BENKRAIEM, Nantua (FR); Serge LAGIER, Moye (FR); Pascal GUERRY, Seppois le Haut (FR)

(73) Assignees: TALLANO TECHNOLOGIES, Paris (FR); AKWEL, Champfromier (FR)

(21) Appl. No.: 18/857,142

(22) PCT Filed: Apr. 13, 2023
(86) PCT No.: PCT/FR2023/050529

§ 371 Date: Oct. 15, 2024

(30) Foreign Application Priority Data
Apr. 15, 2022 (FR) 2203540

(51) Int. Cl. B01D 45/08; F16D 65/00

(52) U.S. Cl. CPC B01D 45/08; F16D 65/0031

(57) ABSTRACT

A device is for capturing liquid particles in a gaseous flow which may be loaded with moisture, includes a body delimiting a cavity defining a mainly vertical flow path for the flow of gaseous air between inlet and outlet ports in an operating configuration of the device. The cavity has a vertical inner separating partition delimiting a settling chamber for the liquid particles to settle out along the main path and a liquid-collection chamber having a negative-pressure zone. The partition has a hole provided at the bottom of the partition and adapted for the suctioning of liquid from the settling chamber to the collection chamber via the effect of negative pressure in the zone.

This invention relates to a device for capturing liquid particles contained in a gaseous flow. It applies more particularly but not specifically to a system for recovering brake dust particles, in particular those emitted during the braking action of a motor vehicle where air is suctioned.

The field of application of the invention relates more particularly but not exclusively to the recovery of brake dust generated during the braking action of a vehicle, whether a road vehicle (for example: automobile, heavy goods vehicle, motorcycle) or a rail vehicle (train, tram, subway).

In general, the braking of a road or rail vehicle, and in particular of a motor vehicle, is carried out by a friction braking system, as is the case for example with “disc brakes”. A disc brake comprises a disc, rotating around an axle fixed to a hub of a wheel of the vehicle, and brake pads provided with linings made of friction material and mounted on each side of the disc by means of a brake caliper.

During a braking action, the brake pads, which are movable relative to the caliper, come to bear against the discs which rotate with the wheels of the vehicle, in order to apply braking torque to them and brake by converting kinetic energy into heat.

However, with each braking action, the friction of the brake pads causes wear in the friction materials of the linings in addition to the release of heat, as well as wear in the metal discs or drums. This wear by abrasion causes significant emission of particles. Since the brakes of a motor vehicle are generally not completely enclosed, these brake dust particles are then directly dispersed into the ambient environment.

In addition to dirtying the immediate environment around the wheels and in particular the rims, these particles are particularly harmful to one's health. Indeed, these particles may be nanoparticles or microparticles, the finest particles being recognized as being particularly harmful to the health of individuals in general, with an increased risk of developing respiratory, allergic, and cardiovascular diseases.

In order to reduce pollution by brake dust particles, it is known from the state of the art to provide a particle suction and filtration system close to the braking system.

Such a filtration system comprises in particular a filtration device provided with a housing delimiting a collection body and accommodating for example a filter cartridge, connectable to an inlet for the flow of dirty air near the pads and to an outlet for the flow of purified air connected for example to a suction fan that pulls in the air. This air circulation then takes place between the inlet and outlet and across the filter cartridge.

The flow of dirty air sucked into this type of filtration system may be more or less loaded with water droplets, depending on meteorological conditions, these droplets then being carried along inside the filtration device.

However, soaking the filter cartridge with liquid significantly degrades the filtration and capture efficiency of the cartridge and may eventually lead to the cartridge tearing under the combined effect of the weight of the liquid and the pressure of the suctioned air passing through it.

In order to unload the liquid particles or droplets from the suctioned flow of air, a device is already known from the prior art, in particular from patent application No. FR2101230 by the Applicant, device which comprises a cyclonic structure upstream of the filter cartridge where large dust particles but also water droplets are collected from the flow of dirty air by centrifugal effect during the passage of the air flow through the cyclonic structure before it passes through the filter cartridge.

However, although this is proving to be highly effective for capturing water, the fact remains that such a cyclonic structure is particularly bulky and greatly increases the complexity of the filtration device.

### DESCRIPTION OF THE INVENTION

The present invention aims to overcome these disadvantages by providing another solution for the elimination of droplets, this solution avoiding the incorporation of additional bulky elements while leading to an effective result.

To this end, the invention relates to a device for capturing liquid particles in a gaseous flow, comprising a body delimiting a cavity defining a mainly vertical flow path for the gaseous flow of air between inlet and outlet ports in an operating configuration of the device, characterized in that the cavity comprises a vertical inner separating partition delimiting a settling chamber for the liquid particles to settle out along said main path and a liquid-collection chamber comprising a negative-pressure zone, the partition comprising a hole provided at the bottom of the partition and adapted for the suctioning of liquid from the settling chamber to the collection chamber via the effect of the negative pressure in said zone.

The invention thus allows collecting moisture from the gaseous flow with a simple and compact solution. By means of the arrangement defined in the invention, the hole in the partition separating the collection chamber and the settling chamber allows filling the collection chamber via the effect of the negative pressure in a zone of the collection chamber.

The device of the invention may further comprise one or more of the following features.

In a preferred embodiment of the invention, the partition comprises an opening for creating a negative pressure in said zone, arranged at the top of the partition.

In a preferred embodiment of the invention, the settling chamber comprises a negative pressure which propagates to the collection chamber through said opening so as to create the negative pressure in said zone.

In a preferred embodiment of the invention, the settling chamber comprises contours configured to generate a head loss along the main flow path of the gaseous flow, producing the negative pressure in the settling chamber.

In a manner that is known per se, head losses in the flow of a fluid or a gaseous flow are drops in pressure due to the resistance that the fluids or gaseous flows may encounter as they flow.

In a preferred embodiment of the invention, the opening is located along the main flow path for the gaseous flow of air and is configured to introduce a narrowing in the cross-sectional area of flow for the gaseous air flow along the main path, or a change in direction of the main path, in order to create a negative pressure in said zone.

In a preferred embodiment of the invention, the opening is provided at the top, at a distance from the suction hole in the vertical direction.

In a preferred embodiment of the invention, as the outlet port is open to the interior of the collection chamber, the main path passes through the partition via the opening provided at the top of the partition before reaching the outlet port via the collection chamber.

In a preferred embodiment of the invention, the mouth of the inlet port faces vertically so as to allow the collected liquid to drain, the liquid being able to flow through the inlet port due to gravity.

In a preferred embodiment of the invention, since the circulation of the flow through the device is created by intermittent suctioning of the flow through the outlet port of the device, the liquid is able to flow when suctioning of the flow through the inlet port is stopped.

In a preferred embodiment of the invention, the main path comprises at least one change of direction.

In a preferred embodiment of the invention, the path comprises a generally “S”-shaped portion formed by two successive bends of different orientations.

In a preferred embodiment of the invention, the suction hole has a generally oblong shape where its longitudinal direction is substantially horizontal.

In a preferred embodiment of the invention, the partition comprises a wall of generally annular shape around a main axis of substantially vertical orientation or comprises a wall that is generally planar in shape.

In a preferred embodiment of the invention, the device comprises connection endpieces for its connection to a system of pipes for the circulation of gaseous flows.

The invention also relates to a system for recovering braking particles, comprising a downstream device for filtering and collecting braking particles comprising an intake port for a flow of dirty air and a discharge port for a flow of purified air, the discharge port being intended to be connected to an air flow suction member in order to cause the air flow to circulate inside the device between the two ports during operation, by means of the suction effect, characterized in that the intake port is connected to the outlet port of an upstream device for capturing liquid particles according to any one of the preceding claims such that the flow of dirty air flows through said device for capturing liquid particles before it enters the intake port of the filtering and collecting device downstream.

Other features and advantages of the invention will become apparent in light of the description which follows, given with reference to the appended drawings in which:

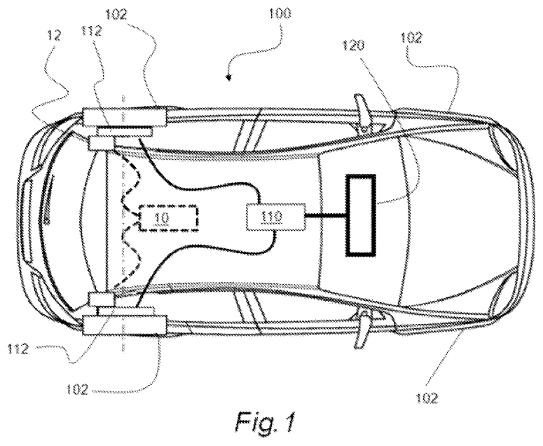

FIG. 1 shows a schematic view of a motor vehicle incorporating a braking particle pollution control system according to the invention;

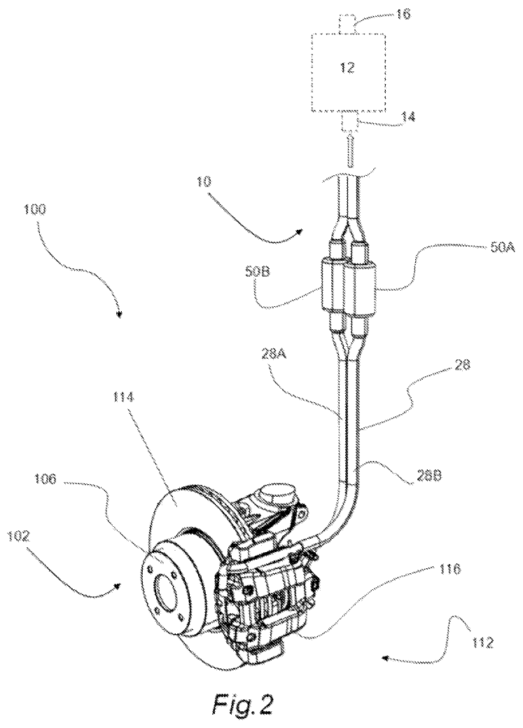

FIG. 2 shows a schematic view of the environment around a wheel of the motor vehicle of FIG. 1, comprising the pollution control system according to a first embodiment of the invention;

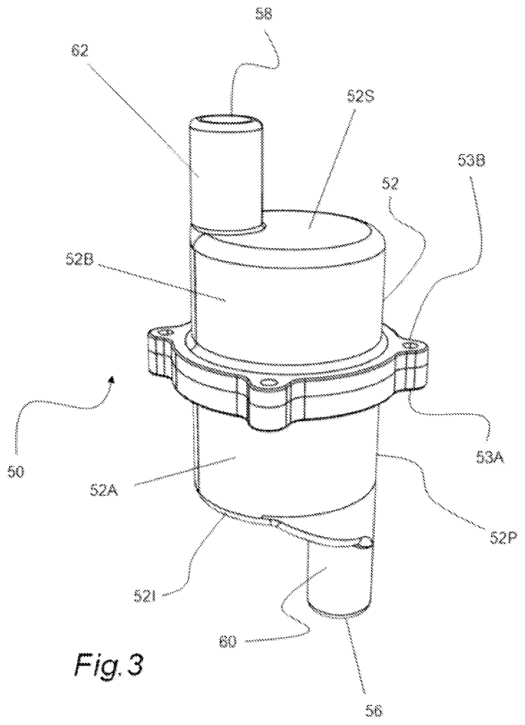

FIG. 3 shows a perspective view of a capture device of the pollution control system of FIG. 2 according to the first embodiment;

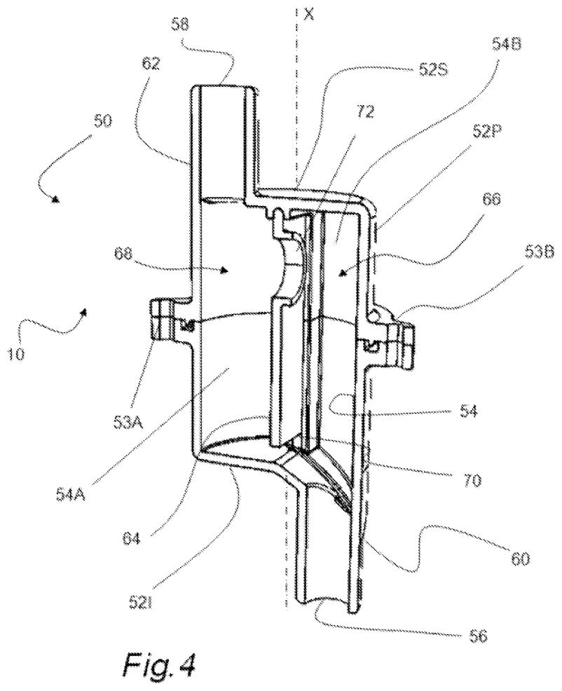

FIG. 4 shows a perspective section view of the device of FIG. 3;

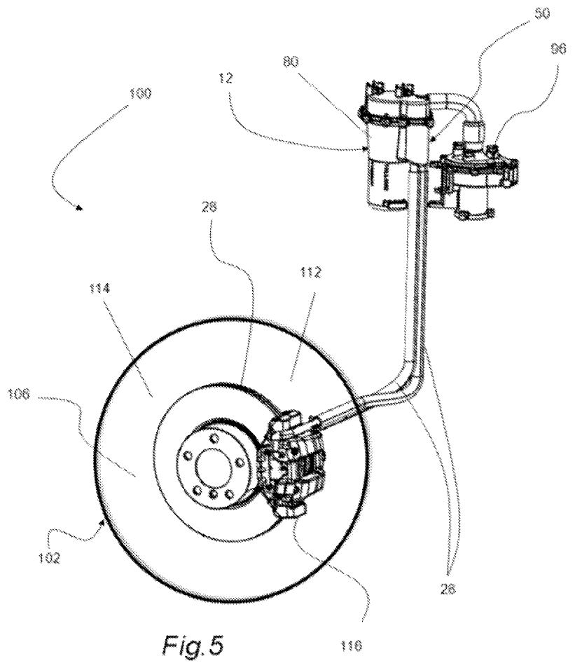

FIG. 5 shows a schematic view of the environment around a wheel of the motor vehicle of FIG. 1 comprising the pollution control system according to a second embodiment of the invention;

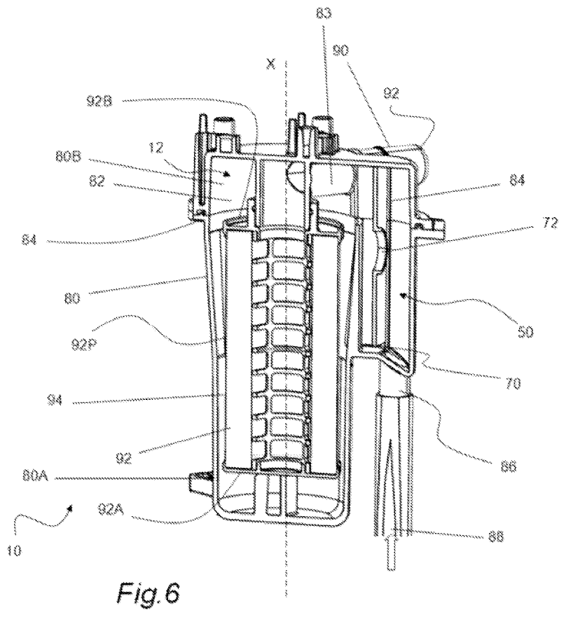

FIG. 6 shows a perspective section view of the device of FIG. 5.

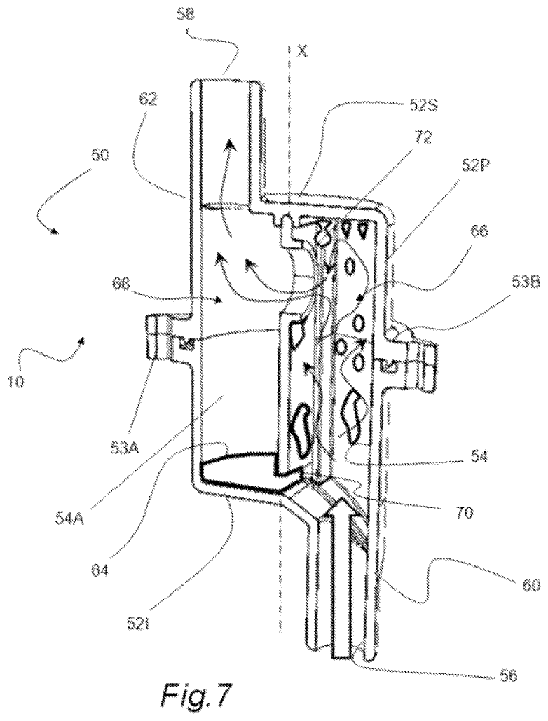

FIG. 7 shows a perspective section view of the device of FIG. 4 during a braking phase.

### DETAILED DESCRIPTION OF THE INVENTION

Represented in FIG. 1 is a motor vehicle comprising a pollution control system of the invention, based on the suctioning and collection of brake dust particles. This system is designated by the general reference 10 and the motor vehicle is designated by the general reference 100. In the preferred embodiment of the invention, vehicle 100 is a motor vehicle, in the illustrated case a light vehicle. Of course, the invention may be applied to other vehicles, such as heavy goods vehicles, rail vehicles, or others.

In a general but non-limiting manner, vehicle 100 comprises four wheels 102 and a braking system 110 which has the function of slowing the vehicle and keeping it stationary, in particular for relatively short periods. Braking system 110 is configured to apply braking torque to at least two of wheels 102 of vehicle 100 and preferably to four wheels 102 of the vehicle. Conventionally, wheels 102 are capable of being driven to rotate by a powertrain, for example a heat engine or an electric motor (not shown) or any other type of propulsion.

To this end, braking system 110 preferably comprises four brake arrangements 112 associated with each of wheels 102, and a unit for managing these brake arrangements (only two brake arrangements 112 are shown in FIG. 1). A user of vehicle 100 may thus control braking system 110 by means of a control unit 120 of vehicle 100 which controls brake arrangements 112 of braking system 110.

Such a brake arrangement 112 is illustrated as an example in FIG. 2. Preferably, arrangement 112 is of the disc brake type. FIG. 2 illustrates brake arrangement 112 mounted on one of wheels 102 of vehicle 100.

Each brake arrangement 112 comprises, in a non-limiting manner, a rotor disk 114 rotating about a main axle and integral in rotation with wheel 102 with which it is associated. This main axle is generally intended to be fixed to a hub 106 of wheel 102 of vehicle 100.

In addition, brake arrangement 112 comprises a caliper bracket 116 arranged straddling an outer edge of disc 114 and integral in rotation with a fixed part of the chassis (not shown) of vehicle 100. Brake arrangement 112 further comprises two brake pads (not directly visible in FIG. 2) provided with linings made of friction material and mounted one on either side of disc 114 by means of caliper bracket 116.

These brake pads are mounted so as to be movable, for example under the effect of a hydraulic cylinder (not shown), and are intended to clamp rotor disc 114 so as to brake it until it comes to a stop by the conversion of kinetic energy into thermal energy. The brake linings are generally made of friction material and release particles resulting from abrasion by friction against disc 114. During braking, the friction between the brake lining and disc 114 generates dust which may contain fine particles that are hazardous to one's health.

In order to recover the brake dust particles, recovery and collection system 10 is intended to suction in and collect the dust particles produced during a braking action of motor vehicle 100, in particular friction braking by brake arrangements 112 of vehicle 100 as described above.

In the illustrated example, system 10 comprises at least one pollution control device 12 according to the invention (represented schematically by a box with dashed lines in FIG. 2) and comprises as many pollution control devices 12 as there are brake arrangements 112. For example, system 10 comprises four pollution control devices 12 to equip four brake arrangements 112 of vehicle 100.

By convention, in the present application, the terms “upstream” and “downstream” are defined in relation to the direction in which the gaseous flow circulates in the illustrated example, namely in the direction going from the brake pads to filtration device 12.

Device 12 has the function of recovering and collecting dust and braking particles, for example originating from one of the braking arrangements of the motor vehicle. Conventionally, device 12 is generally in the form of a housing provided with an intake port 14 for the flow of dirty air and a discharge port 16 for the flow of purified air, and delimiting a body for the collection of dust particles.

For this purpose, device 12 comprises a housing body which 30 accommodates at least one separating member (not shown in FIG. 2) for separating particles from the flow of dirty air, which the air flow circulates through between the two ports 14 and 16. In the example described, the separating member comprises for example a filter cartridge. Furthermore, preferably, such a housing is sized to be accommodated in a space surrounding a wheel 102 of a motor vehicle 100, for example around a strut of a suspension system.

Furthermore, as is schematically illustrated in FIG. 2, the housing of device 12 may be connected, via a suction channel 28 for example formed by hoses 28A, 28B, to one of disc brake arrangements 112. Preferably, suction channel 28A, 28B comprises having one of its ends located in the immediate vicinity of the area where brake dust is likely to be generated. The other of its ends preferably leads to inside the collection body of device 12.

In order to cause efficient air circulation inside device 12, a suction member for suctioning the flow of purified air, such as a centrifugal pump for example, is arranged downstream of device 12. In the described example, discharge port 16 of filtration device 12 is intended to be connected to a suction member for suctioning the air flow in order to cause circulation of the air flow, via the suction effect, through the filter cartridge between intake port 14 and discharge port 16.

In accordance with the invention, system 10 further comprises a capture device 50 for capturing liquid particles in the flow of dirty air which may be loaded with moisture. In effect, the flow of dirty air is captured at wheel 102 of motor vehicle 100 which is exposed to frequent splashing, in particular during wet weather. These liquid particles may be water but possibly also oil.

In this first embodiment of the invention, as shown in FIG. 2, capture device 50 for capturing liquid particles is mounted on a branch of suction channel 28, upstream of filtration device 12. For example, pollution control system 10 comprises two capture devices 50A and 50B respectively mounted one on each of hoses 28A and 28B. In the remainder of the description, only one of the two capture devices will be described, using the general reference 50.

A capture device 50 of the first embodiment is illustrated in detail in FIGS. 3 and 4. As shown in these figures, device 50 comprises a body 52 delimiting a cavity 54 and inlet 56 and outlet 58 ports for the air flow. As shown in FIG. 2, device 50 is connected to the circulation circuit of the suction system 10, upstream of particle filtration device 12.

In the example illustrated, externally the body 52 of capture device 50 is generally in the form of a housing. In the present case, housing 52 has a peripheral wall 52P of generally cylindrical shape around a main axis X and is provided with lower 52I and upper 52S end faces.

By convention, in this application the terms “inner” and “outer”, “lower” and “upper”, and “internal” and “external” are defined radially relative to the main axis X of capture device 50.

Housing 52 is for example in two parts 52A and 52B which may be assembled together by various releasable or non-releasable assembly methods which will not be detailed further. For example, each part 52A or 52B comprises a respective peripheral lower 53A and upper 53B attachment flange enabling assembly of the two parts 52A, 52B, for example by means of conventional fastening screws or any other means of assembly.

Furthermore, housing 52 is provided with an inlet endpiece 60 and an outlet endpiece 62 which respectively delimit inlet port 56 and outlet port 58. The two ports, inlet 56 and outlet 58, lead to the interior of cavity 54.

According to the invention, in an operating configuration of device 50, inlet 56 and outlet 58 ports respectively lead to lower 54A and upper 54B portions of cavity 54 in order to define a mainly vertical flow path for the gaseous air flow between inlet 56 and outlet 58 ports in an operating configuration of device 50. In the example illustrated, this vertical direction substantially coincides with the direction of the main axis X of device 50 in the operating configuration of device 50.

According to the invention, cavity 54 comprises a vertical inner separating partition 64 delimiting a first chamber 66 for allowing liquid particles in the gaseous flow to settle out, which inlet port 56 leads into, and a second chamber 68 for recovering or collecting the liquid particles captured in first chamber 66.

Partition 64 is preferably formed by a wall of generally planar shape delimiting the two chambers 66 and 68 in the vertical direction. In a variant not illustrated in the figures, partition 64 may be in an annular shape around an axis of revolution that is also vertical in orientation, in the operating configuration of device 50.

More precisely, settling chamber 66 extends along said main flow path of the gaseous flow. This can be seen in FIG. 7: the liquid particles are schematically represented in settling chamber 66.

Furthermore, in particular, collection chamber 68 for collecting liquid particles comprises a negative-pressure zone. In particular, inner partition 64 comprises a hole 70 formed at the bottom of partition 64 and arranged for the suctioning of liquid from settling chamber 66 towards collection chamber 68 by means of the effect created by the negative pressure in said zone.

For example, suction hole 70 is preferably provided at the lowest point of partition 64. For example, partition 64 has a notch in a lower edge delimiting hole 70 which is in the form of a slot delimited by partition 64 and the bottom of cavity 54. In FIG. 7, one can see in particular that recovery chamber 68 is filled with liquid in a zone that is in communication with hole 70. More generally, and preferably, hole 70 is in the form of an oblong opening extending in a longitudinal direction perpendicular to the vertical direction.

Preferably, partition 64 further comprises an opening 72 for creating the negative pressure in the negative-pressure zone of collection chamber 68, arranged at the top of partition 64.

For example, settling chamber 66 comprises a negative pressure which propagates to collection chamber 68 via said opening 72 so as to cause a negative pressure to be established in said area 70. For example, settling chamber 66 may comprise contours (not shown) configured to generate singular head loss along the main flow path of the gaseous flow, which generates negative pressure in settling chamber 66.

In the example illustrated in the figures, opening 72 is located along the main flow path of the gaseous air flow and is configured to introduce a change in the direction of the main path, which has the effect of generating head loss. The effect of this head loss is to cause a negative pressure to be established in said zone in collection chamber 68.

Alternatively, opening 72 may introduce a narrowing in the cross-sectional area for the gaseous flow along the main path, which also has the effect of generating head loss and thus causing a negative pressure to be established in said zone in collection chamber 68.

Preferably, outlet port 62 is open to the interior of collection chamber 68 in upper portion 54B of cavity 54, and intermediate opening 72 for the gaseous flow to travel along the flow path is provided at the top of partition 64. In the illustrated example, outlet port 62 is provided in upper end wall 52S of body 52. However, alternatively, outlet port 62 may extend laterally through peripheral wall 52P of housing 52.

Preferably, the mouth of inlet port 60 faces vertically in order to allow draining the collected liquid, which is able to flow through inlet port 60 due to gravity. In the example illustrated in the figure, inlet port 60 is provided in bottom wall 521 of body 52 of device 50 so that inlet port 60 also forms a drain port for the liquid, which then can flow passively, due to gravity, through inlet port 60.

In particular, in the case of using capture device 50 for capturing liquid in braking particle recovery system 10, the circulation of the gaseous flow through device 50 is created by intermittent suctioning of the flow exiting capture device 50. Indeed, outside of the braking phases, the suction fan which pulls in the gaseous flow is stopped such that the circulation of the fluid is interrupted inside capture device 50.

The intermittent circulation of the gaseous flow inside device 50 allows regularly emptying the liquid stored by collection chamber 68, through inlet port 60 which also forms a drain port for the liquid which is able to flow passively, due to gravity, through inlet port 60 when the flow suction stops, i.e. outside of braking phases.

Capture chamber 66 is in communication with outlet port 58 of capture device 50. Preferably, outlet port 58 is open to the interior of collection chamber 66, and intermediate opening 72 is provided at the top of partition 64, at a distance from suction hole 70 in the vertical direction. Opening 72 in the upper part of partition 64 allows the cleansed air to pass through for release to the outside via outlet port 58.

In the present case, settling chamber 66 forms a volume to contain the impacts and turbulence of the gaseous flow passing through it, which induces, by means of impacts against the walls of chamber 66, an agglomeration of the liquid particles which settle at the bottom of capture chamber 66 due to gravity.

For example, as illustrated in FIG. 4, the main path comprises at least one change of direction, for example forming at least one bend. Preferably, the main path comprises a substantially vertical portion downstream and an angled portion upstream. The angled portion has, for example, a general “S” shape, in the form of two successive bends of opposite orientations relative to each other.

As shown in the illustrated example, the flow path passes through partition 64 via opening 72 provided at the top of partition 64, forming a first bend before reaching outlet port 58 via collection chamber 66, which forms a second bend of reverse orientation. Alternatively, the mouth of outlet port 58 may extend laterally, through peripheral wall 52P of housing body 52 of capture device 50 so that the flow path comprises only one bend.

FIGS. 5 and 6 show a capture device 50 according to a second embodiment. In this second embodiment, elements similar to those of the first embodiment bear identical references.

In this second embodiment, as can be seen in FIG. 5, downstream device 12 for filtering and collection and upstream device 50 for capturing are formed as a single piece in a common housing body 80, respectively comprising a main downstream compartment 82 for collection and filtration and a secondary upstream compartment 84 for capturing liquid particles, and the two devices 50 and 12 are in communication with each other respectively via their intake port and outlet port.

In FIG. 6, secondary compartment 84 forms an extension of main compartment 82 for housing device 50 for capturing liquid particles. Advantageously, such an arrangement facilitates the manufacturing and production operations for such a product, for example by injection molding in a single mold with a parting line.

As illustrated in FIG. 6, housing body 80 has a generally tubular shape, for example cylindrical around a main axis X. Housing 80 appears for example in two parts 80A and 80B which may be assembled together by various releasable or non-releasable methods of assembly which will not be further detailed.

Furthermore, housing body 80 comprises an inlet port 88 for a flow of dirty air loaded with dust particles and liquid particles and collected from the immediate environment around brake pads 118, for example by means of a hose 28. The body of housing 80 further comprises a discharge port 92 for discharging the flow of purified air cleared of microdroplets after the flow has passed through the two devices 12 and 50. As can be seen in FIG. 5, the outlet of discharge port 92 is connected by an elbow pipe to a suction fan 96.

Inlet port 88 leads in the illustrated example to the interior of secondary compartment 84. For this purpose, housing 80 further comprises a connector endpiece 86 intended to be connected to inlet port 88 and to be connected to one or two hoses 28 which lead to the vicinity of brake arrangement 116 schematically represented in FIG. 5.

Device 12, housed in main compartment 82, comprises a filter cartridge 92 configured to filter the air in a radial direction. For this purpose, cartridge 92 comprises an elongate filtering peripheral wall 92P extending longitudinally along axis X and of generally annular shape around a central hollow interior space 94. Interior space 94 thus defines an internal channel for discharging air after its filtration in cartridge 92 across filtering wall 92P.

Peripheral wall 92P of filter cartridge 92 is formed for example of an annular filter medium and comprises two support plates, lower 92A and upper 92B, which the filter medium extends between, axially and longitudinally. Peripheral wall 92P further comprises, in the illustrated example, an inner annular perforated partition rigidly connecting the two support plates 92A, 92B and peripherally delimiting the internal passage for the air after filtration. This filter medium is made of a filtering material, for example microporous, molded or accordion-pleated in the manner of a bellows. Filter cartridge 92 thus preferably has a general shape of revolution around axis X. Alternatively, peripheral wall 92P may be devoid of this inner partition and the filtering medium may be made of a material sufficiently rigid to allow rigidly retaining the two support plates 92A, 92B.

Preferably, upper flange 92B delimits an opening for discharging the air filtered through the filtering medium, which is in communication with the internal channel of cartridge 92. In addition, body 80 further comprises a port 90 for discharging the flow of purified air, leading to the interior of main compartment 82 and for example in communication with the internal channel of cartridge 92.

Preferably, cartridge 92 is intended to be mounted so as to be suspended inside upper part 80B of housing 80. For example, upper part 80B is provided internally, in the extension of its discharge opening, with an internal fluid channel segment from which cartridge 92 is suspended. For example, the upper support flange is provided, around its opening, with fastening means configured to engage sealingly around said channel portion. The fastening means may comprise any type of fastening, such as snap-fastening, force-fitting, bayonet fitting, welding, etc.

As is clear from the figures, the main downstream compartment 82 for collection and filtration and the upstream compartment 84 for capturing liquid particles are in communication with each other respectively via the intake port of device 12 and the outlet port of device 50. Preferably, as illustrated in FIG. 6, the intake port and the outlet port are merged into a common port 83. One can see, for example, that common port 83 leads laterally to the interior of the two compartments 82 and 84.

We will now describe the main aspects of a device for capturing liquid particles in a gaseous flow according to the first and second embodiments, with reference to FIGS. 1 to 7.

During a first step, the user of vehicle 10 actuates the brake of vehicle 10. During this braking action, brake dust particles related to the abrasion of the brake linings are released. When the brake is actuated, braking system 10 simultaneously controls the starting of the suction fan located downstream of pollution control device 12.

The flow of dirty air, which may be loaded with liquid particles, is then drawn in by suction through hose 28 and first enters capture device 50. It then enters settling chamber 66 where it releases its liquid particles which settle to the bottom of chamber 66 due to gravity. The settled liquid particles are then suctioned into collection chamber 68 through suction hole 70 due to the effect of negative pressure (FIG. 7).

The flow of dirty air thus cleared of microdroplets continues its path out of capture device 50 and reaches pollution control device 12. It is cleaned of some of its dust particles by means of the separating member(s) it passes through during its journey inside device 12. The flow of dirty air thus purified exits through the discharge port of pollution control device 12.

Of course, the invention is not limited to the embodiments described above. Other embodiments within the reach of those skilled in the art may also be envisaged without departing from the scope of the invention defined by the claims below.

1-16. (canceled)

17. A device for capturing liquid particles in a gaseous flow, the device comprising: a body delimiting a cavity defining a main flow path for the gaseous flow between an inlet port and an outlet port, the main flow path being vertical in an operating configuration of the device, wherein the cavity comprises a partition that is vertical, the partition separating a settling chamber for the liquid particles to settle out along said main flow path from a liquid-collection chamber comprising a negative-pressure zone, the partition comprising a hole at a bottom of the partition and adapted for suctioning the liquid particles from the settling chamber to the liquid-collection chamber via an effect of negative pressure in said negative-pressure zone.

18. The device according to claim 17, wherein the partition comprises an opening for creating the negative pressure in said negative-pressure zone, the opening being arranged at the top of the partition.

19. The device according to claim 18, wherein the settling chamber comprises negative pressure which propagates to the liquid-collection chamber through said opening to create the negative pressure in said negative-pressure zone.

20. The device according to claim 19, wherein the settling chamber comprises contours configured to generate a head loss along the main flow path of the gaseous flow, and producing the negative pressure in the settling chamber.

21. The device according to claim 18, wherein the opening is located along the main flow path for the gaseous flow of air and is configured to introduce a narrowing in a cross-sectional area encountered by the gaseous flow along the main path, to create the negative pressure in said negative-pressure zone.

22. The device according to claim 18, wherein the opening is located along the main flow path for the gaseous flow of air and is configured to introduce a change in direction of the main path to create the negative pressure in said negative-pressure zone.

23. The device according to claim 18, wherein the opening is at a top of the partition and at a distance from the hole in the vertical direction.

24. The device according to claim 18, wherein, as the outlet port is fluidly connected to the collection chamber, the gaseous flow passes through the partition via the opening at the top of the partition before reaching the outlet port via the collection chamber.

25. The device according to claim 17, wherein the mouth of the inlet port faces vertically to allow the collected liquid particles to drain, the liquid particles being able to flow through the inlet port due to gravity.

26. The device according to claim 25, wherein an intermittent suctioning is generated at the outlet port and the liquid particles are able to flow through the inlet port as the suctioning of the gaseous flow is stopped.

27. The device according to claim 17, wherein the main flow path comprises at least one change of direction.

28. The device according to claim 17, wherein the main flow path comprises a generally “S”-shaped portion formed by two successive bends of different orientations.

29. The device according to claim 17, wherein the hole has a generally oblong shape, the oblong shape having a horizontal longitudinal direction.

30. The device according to claim 17, wherein the partition comprises a wall of generally annular shape around a main axis of substantially vertical orientation.

31. The device according to claim 17, wherein the partition comprises a generally planar wall.

32. The device according to claim 17, further comprising connection endpieces for connecting the inlet port and the outlet port to a system of pipes.

33. A system for recovering braking particles, comprising a downstream device for filtering and collecting braking particles and an upstream device for capturing liquid particles;
the upstream device comprising a body delimiting a cavity defining a main flow path for gaseous flow between an inlet port and an outlet port, the main flow path being vertical in an operating configuration of the device, wherein the cavity comprises a partition that is vertical, the partition separating a settling chamber for the liquid particles to settle out along said main flow path from a liquid-collection chamber comprising a negative-pressure zone, the partition comprising a hole at a bottom of the partition and adapted for suctioning the liquid particles from the settling chamber to the liquid-collection chamber via an effect of negative pressure in said negative-pressure zone; and
the downstream device comprising an intake port for a flow of dirty air and a discharge port for a flow of purified air, the discharge port being configured to be connected to an air flow suction member in order to cause an air flow to circulate inside the downstream device between the two ports, by suction;
wherein the intake port of the downstream device is connected to the outlet port of the upstream device for capturing liquid particles, so that the flow of dirty air flows through said upstream device before the flow of dirty air enters the intake port of the downstream device.

34. The system according to claim 33, wherein the downstream device and the upstream device are formed as a single piece in a common housing body, respectively comprising a main downstream compartment for collection and filtration, and an upstream compartment for capturing liquid particles, the downstream compartment and the upstream compartment being in communication with each other respectively via the intake port and the outlet port.
